(19) United States
(12) Patent Application Publication
(10) Pub. No.: US 2023/0191918 A1
(43) Pub. Date: Jun. 22, 2023

(54) VEHICLE CONTROL SYSTEM

(71) Applicant: TOYOTA JIDOSHA KABUSHIKI KAISHA, Toyota-shi (JP)

(72) Inventor: Kunihiko USUI, Fuji-shi (JP)

(73) Assignee: TOYOTA JIDOSHA KABUSHIKI KAISHA, Toyota-shi (JP)

(21) Appl. No.: 18/082,974

(22) Filed: Dec. 16, 2022

(30) Foreign Application Priority Data
Dec. 22, 2021 (JP) 2021-208028

(51) Int. Cl. B60L 15/20; B60L 50/00; B60Q 9/00

(52) U.S. Cl. CPC B60L 15/20; B60L 50/00; B60Q 9/00; B60L 2240/62; B60L 2240/647; B60L 2240/12; B60L 2240/423

(57) ABSTRACT

A vehicle control system that allows a vehicle to travel easily and smoothly on a slippery road, a bumpy road, and a narrow road. A controller of the vehicle control system comprises: a running condition determiner that determines whether the vehicle travels under the particular condition; a control mode selector that selects one of vehicle speed control modes; and a driving force controller that controls a driving force such that an actual vehicle speed is adjusted to a target vehicle sped based on the selected vehicle speed control mode.

### CROSS-REFERENCE TO RELATED APPLICATIONS

The present disclosure claims the benefit of Japanese Patent Application No. 2021-208028 filed on Dec. 22, 2021 with the Japanese Patent Office, the disclosures of which are incorporated herein by reference in its entirety.

### BACKGROUND

### Field of the Disclosure

Embodiments of the present disclosure relate to the art of control system for a vehicle configured to control driving force during propulsion in particular road conditions e.g., during propulsion on a slippery road surface where a coefficient of friction is low, a rough road surface where a running resistance changes significantly and frequently, and a narrow road.

### Discussion of the Related Art

For example, in order to drive over a bump, it is necessary to generate an excess driving force in addition to a driving force required driving force to drive over the bump. However, after passing a top of the bump, a road load is reduced and hence the vehicle would be accelerated abruptly by an excessive driving force.

JP-A-2007-045230 discloses a driving force controller configured to reduce driving torque when a vehicle has passed over a step to avoid the above-mentioned disadvantage. Specifically, when the vehicle reaches a step, a driver reduces a speed of the vehicle, and then depress an accelerator pedal to increase a driving torque to drive over the step. Consequently, the speed of the vehicle is increased when the driving torque is increased to a required torque to drive over the step. According to the teachings of JP-A-2007-045230, the controller determines that the vehicle has passed over the step when a moving average of an angular acceleration increases to a preset value or greater, and reduces the driving torque as indicated in the graph upon satisfaction of such determination.

JP-A-2007-085207 discloses a driving force control device that controls driving force during propulsion on a large resistance slippery road such as a sandy road surface or a snow-covered road surface. According to the teachings of JP-A-2007-085207, the control device is configured to adjust a speed of a driveshaft to a predetermined value during propulsion on the large resistance slippery road, instead of carrying out a traction control. Specifically, the control device taught by JP-A-2007-085207 is configured to set a target speed of the driveshaft with reference to a map determining a relation between a position of an accelerator pedal and a speed of the driveshaft during propulsion on the large resistance slippery road, and to control the driving force in such a manner as to achieve the target speed of the driveshaft. According to the teachings of JP-A-2007-085207, therefore, drive wheels are rotated without stopping so that the vehicle is allowed to travel on the large resistance slippery road while sputtering snow and sand.

As described in JP-A-2007-045230, a vehicle is allowed to drive over a bump by generating the excess driving force by depressing the accelerator pedal. However, if the accelerator pedal is depressed deeper than necessary, the excess driving force would be increased excessively. In this situation, although the vehicle is allowed to climb the bump promptly to the top, a speed of the vehicle would be raised excessively after passing the top of the bump, and hence the driver would be urged to decelerate the vehicle abruptly. In order to avoid such disadvantage, according to the teachings of JP-A-2007-045230, the driving force is reduced to prevent an abrupt acceleration of the vehicle after passing over the bump. However, since the vehicle is decelerated abruptly after passing over the bump, the driver would feel uncomfortable feeling. By contrast, if the depression of the accelerator pedal is insufficient, the vehicle is not allowed to climb over the bump smoothly, and hence the driver is urged to depress the accelerator pedal again. Thus, although JP-A-2007-045230 describes the torque reducing control that is executed when the vehicle passes over the bump, JP-A-2007-045230 is silent about a control before the vehicle reaches the bump. Therefore, the driving force reduction control described in JP-A-2007-045230 has to be improved to drive over the bump smoothly.

On the other hand, according to the teachings of JP-A-2007-085207, the target speed of the driveshaft is set based on a position of the accelerator pedal with reference to the map, and the driving force is controlled in such a manner as to achieve the target speed of the driveshaft. According to the teachings of JP-A-2007-085207, therefore, the driving force with respect to the position of the accelerator pedal has to be set in a unified manner. That is, the vehicle to which the control device taught by JP-A-2007-085207 is applied is allowed to travel on a sandy road surface or a snow-covered road surface, but the driving force may not be controlled properly on an uneven road surface on which many bumps or rocks exist.

Thus, it is necessary to control the driving force sensitively and promptly on a slippery road and a bumpy road. Likewise, it is also necessary to control the driving force sensitively and promptly on a narrow road including a garage where each clearance between a vehicle and side obstacles is narrow, so as to propel the vehicle smoothly in either forward or reverse direction. In order to control a driving force and a vehicle speed properly during propulsion in the above-mentioned particular conditions, it is necessary to improve the conventional vehicle control systems.

### SUMMARY

Aspects of embodiments of the present disclosure have been conceived noting the foregoing technical problems, and it is therefore an object of the present disclosure to provide a vehicle control system that allows a vehicle to travel easily and smoothly on a slippery road surface, a rough road surface, and a narrow road.

The exemplary embodiment of the present disclosure relates to a vehicle control system that controls a driving force delivered from a prime mover to wheels in accordance with an accelerating operation or a decelerating operation. In order to achieve the above-explained objective, according to the exemplary embodiment of the present disclosure, the vehicle control system is provided with a controller that controls a speed of a vehicle. Specifically, the controller comprises: a running condition determiner that determines whether the vehicle travels under a particular set of conditions in which a maximum speed of the vehicle has to be limited; a plurality of vehicle speed control modes each of which determines a relation between an amount of the accelerating operation or decelerating operation and a target vehicle speed under the particular set of conditions; a control mode selector that selects one of the vehicle speed control modes; and a driving force controller that controls the driving force such that an actual vehicle speed is adjusted to the target vehicle speed based on the selected vehicle speed control mode.

In a non-limiting embodiment, the vehicle may include an electric vehicle in which the prime mover includes a motor that generates the driving force.

In a non-limiting embodiment, the particular set of conditions may include: a road surface having a bump on which the vehicle travels over; an uneven road surface on which any of the wheels may be stuck between bumps or in a dent; and a slippery road surface on which a friction coefficient is lower than that on a dry road surface.

In a non-limiting embodiment, the vehicle may comprise a safety system that gives a warning when a clearance between the vehicle and an obstacle is a predetermined value or narrower. In addition, the particular set of conditions may further include a narrow road on which the safety system gives the warning.

In a non-limiting embodiment, any of the vehicle speed control mode may be configured to determine the relation between the amount of the accelerating operation or decelerating operation and the target vehicle speed linearly or non-linearly, or limit a maximum target vehicle speed to a value different from a maximum speed in the other vehicle speed control modes.

In a non-limiting embodiment, the control mode selector may be configured to select the one of the vehicle speed control modes based on a signal transmitted from a switch that is operated manually by a driver of the vehicle.

Thus, according to the exemplary embodiment of the present disclosure, any one of the vehicle speed control modes is selected when the vehicle travels under the particular set of conditions. As described, the particular set of conditions include: the road surface having a bump on which the vehicle travels over; the uneven road surface on which any of the wheels may be stuck between bumps or in a dent; the slippery road surface on which a friction coefficient is lower than that on a dry road surface; and the narrow road where a clearance between the vehicle and an obstacle is narrow.

In the vehicle speed control mode, the target vehicle speed is set with respect to an operation of an accelerator pedal or a brake pedal. According to the exemplary embodiment of the present disclosure, the vehicle speed control mode is selected from: a mode in which the target vehicle speed is changed linearly with respect to an operation of e.g., the accelerator pedal; a mode in which the target vehicle speed is changed non-linearly with respect to an operation of e.g., the accelerator pedal; a mode in which the maximum target vehicle speed with respect to a maximum operating amount of the accelerator pedal (or a minimum operating amount of the brake pedal) is limited to a predetermined low speed; and a mode in which the maximum target vehicle speed with respect to a maximum operating amount of the accelerator pedal (or a minimum operating amount of the brake pedal) is limited to an extremely low speed. The vehicle speed control mode may be selected not only manually by the driver, but also automatically based on positional information obtained by a navigation system and road information obtained from a satellite, an inter-vehicle communication system, a sign post etc.

As described, the driving force controller is configured to control the driving force such that the actual vehicle speed is adjusted to the target vehicle sped based on the selected vehicle speed control mode. According to the exemplary embodiment of the present disclosure, therefore, the speed of the vehicle will not be further increased from a speed corresponding to an actual position of e.g., the accelerator pedal under the particular set of conditions. For this reason, the vehicle is allowed to travel over the bump at a desired speed by merely maintaining a position of the accelerator pedal, and the speed of the vehicle will not be increased undesirably even after travelling over the bump. Likewise, the vehicle is also allowed to travel smoothly on an uneven upslope on which a plurality of bumps exist by maintaining a position of the accelerator pedal without increasing the speed of the vehicle undesirably after climbing each bump. In addition, since the speed of the vehicle may be maintained easily to an extremely low speed, the vehicle is allowed to travel though a narrow road easily and smoothly without rubbing against a side obstacle.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a skeleton diagram schematically showing one example of a structure of a vehicle to which the control system according to the exemplary embodiment of the present disclosure is applied;

FIG. 2 is a block diagram showing one example of a structure of the control system;

FIG. 3 is a flowchart showing one example of a routine executed by the control system according to the exemplary embodiment of the present disclosure;

FIGS. 4A to 4D are maps determining a relation between a position of an accelerator pedal and a target vehicle speed in each speed control mode; and

FIG. 5 is a time chart showing one example of temporal changes in a vehicle speed and a driving torque during execution of the routine shown in FIG. 3.

### DETAILED DESCRIPTION OF THE PREFERRED EMBODIMENT(S)

Embodiments of the present disclosure will now be explained with reference to the accompanying drawings. Note that the embodiments shown below are merely examples of the present disclosure, and do not limit the present disclosure.

The vehicle control system according to the exemplary embodiment of the present disclosure may be applied to any of: an engine-driven vehicle in which a gasoline engine or a diesel engine serves as a prime mover; a hybrid vehicle in which a prime mover includes an engine and a motor or a motor-generator; and an electric vehicle in which a motor serves as a prime mover. In addition, the vehicle control system according to the exemplary embodiment of the present disclosure may be applied not only to a two-wheel drive layout vehicle in which any one of a pair of front wheels and a pair of rear wheels is driven, but also to an all-wheel drive layout vehicle (e.g., four-wheel drive vehicle) in which all of the wheels are driven. In order to control a driving force to propel the vehicle promptly and sensitively, it is preferable to apply the vehicle control system according to the exemplary embodiment of the present disclosure to the hybrid vehicles or the electric vehicles.

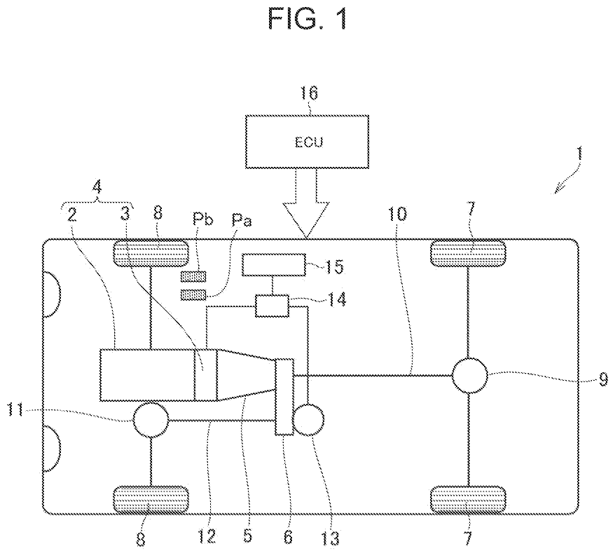

Turning now to FIG. 1, there is shown one example of a structure of a rear-wheel drive based four-wheel drive layout vehicle (hereinafter referred to as vehicle) 1 to which the vehicle control system according to the exemplary embodiment of the present disclosure is applied. As shown in FIG. 1, a prime mover 4 of the vehicle 1 includes an engine 2 and a first motor 3, and a transmission 5 is connected to an output side of the prime mover 4. For example, a gasoline engine and a diesel engine may be adopted as the engine 2, and a motor-generator such as a permanent magnet synchronous motor may be adopted as the first motor 3. The transmission 5 may not only be a geared transmission but also a continuously variable transmission, and a transfer 6 is connected to an output side of the transmission 5.

The transfer 6 is a conventional power transmission unit that distributes an output torque of the prime mover 4 to a pair of front wheels 8 and a pair of rear wheels 7. For example, the transfer 6 may be configured to: shift a driving mode between a two-wheel drive mode and a four-wheel drive mode; allow the front wheels 8 and the rear wheels 7 in a differential manner; and selectively restrict a differential rotation between the front wheels 8 and the rear wheels 7. Specifically, the transfer 6 is connected to a rear differential gear unit 9 as a final reduction through a rear propeller shaft 10, and to a front differential gear unit 11 as a final reduction through a front propeller shaft 12.

A second motor 13 is connected to the front propeller shaft 12, and for example, a motor-generator such may also be adopted as the second motor 13. The first motor 3 and the second motor 13 are connected with an electric storage device 15 through a motor controller 14 including an inverter and a converter. In the vehicle 1, therefore, the second motor 13 may be driven by electric power generated by the first motor 3, the first motor 3 and the second motor 13 may be driven by electric power supplied from the electric storage device 15, and the electric storage device 15 may be charged with electric powers generated by the first motor 3 and the second motor 13. Here, it is to be noted that the prime mover 4 further includes the second motor 13.

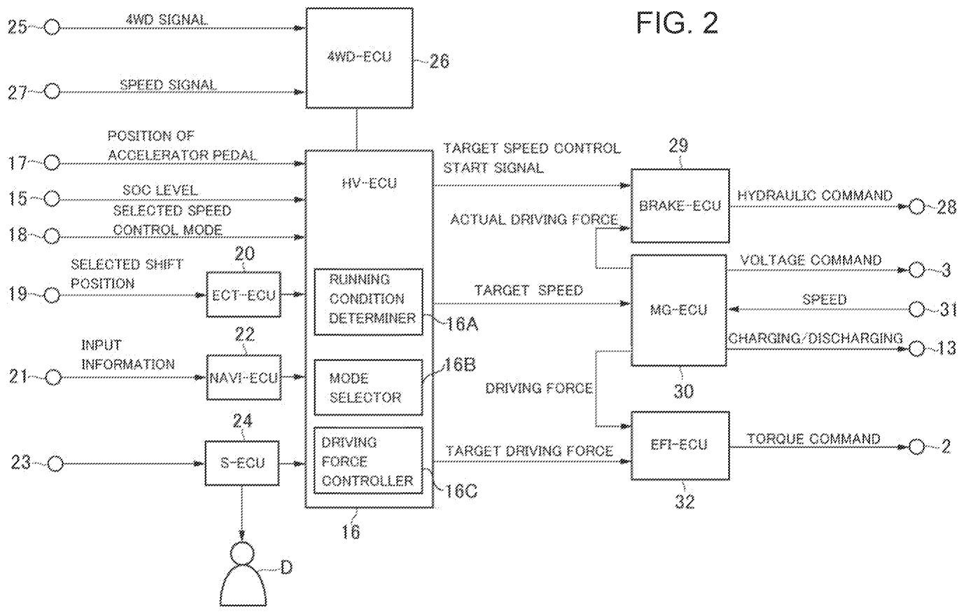

The vehicle 1 is provided with an accelerator pedal Pa that is operated to accelerate and decelerate the vehicle 1, and a brake pedal Pb that is operated to decelerate and stop the vehicle 1. In addition, although not shown in FIG. 1, the vehicle 1 is further provided with a steering wheel that turns e.g., the front wheels 8, brakes shown in FIG. 2 that apply braking forces to the wheels 7 and 8, a shifting device 19 shown in FIG. 2 having a shift lever that is operated to execute a speed change operation of the transmission 5, and a navigation system 21 shown in FIG. 2 that indicates a map including road information to navigate the vehicle to a destination.

The driving forces generated by the engine 2, the first motor 3, and the second motor 13 are controlled by a hybrid control unit (hereinafter abbreviated as “HV-ECU”) 16 as a controller comprising a central processing unit, a read only memory, and a random access memory. The HV-ECU 16 is configured to perform calculation based on incident data and stored data, and transmit calculation results to after-mentioned control units in the form of command signal. The control system of the vehicle 1 is shown in FIG. 2 in more detail. As indicated in FIG. 2, the incident signal to the HV-ECU 16 includes: a signal representing a position, a depression, or an angle of the accelerator pedal Pa (or 17); a signal representing a state of charge level of the electric storage device 15; and a signal representing a position of a control mode selector switch 18 that selects a speed control mode of the vehicle 1. Specifically, the control mode selector switch 18 transmits a signal representing the selected speed control mode and a command signal to execute an after-mentioned target speed control, when it is operated manually by a driver (or passenger) D.

In addition, a signal representing a shift position selected by the shifting device 19 is transmitted from the shifting device 19 to the HV-ECU 16 via a transmission control unit (indicated as “ECT-ECU” in FIG. 2) 20. For example, a destination and a desired route to the destination are entered into the navigation system 21 by the driver D, and such input information to the navigation system 21 is transmitted to the HV-ECU 16 via a navigator control unit (indicated as “NAVI-ECU” in FIG. 2) 22. A clearance between the vehicle 1 and an obstacle (e.g., a wall) is detected by a clearance sensor 23, and a signal representing the clearance is transmitted from the clearance sensor 23 to the HV-ECU 16 via a safety control unit (indicated as “S-ECU” in FIG. 2) 24. That is, the clearance sensor 23 and the safety control unit 24 serve as a safety system of the exemplary embodiment of the present disclosure. Specifically, the safety system gives a tangible, visible, or auditory warning to the driver D if the clearance between the vehicle 1 and the obstacle is a predetermined value or narrower, and a road where the warning is provided by the safety system is one example of the “narrow road” included in the particular conditions of the exemplary embodiment of the present disclosure.

As described, the driving mode of the vehicle 1 may be selected from the two-wheel drive mode and the four-wheel drive mode. Further, the four-wheel drive mode may be selected from a high four-wheel drive mode in which a speed ratio is relatively small, and a low four-wheel drive mode in which a speed ratio is relatively large. Specifically, the operating mode is selected by operating a driving mode selector switch 25, and a signal representing the selected four-wheel drive mode is transmitted from the driving mode selector switch 25 to the HV-ECU 16 via a four-wheel drive control unit (indicated as “4WD-ECU” in FIG. 2) 26. The vehicle 1 is provided with a wheel speed control system that maintains a speed of the vehicle 1 to a predetermined low speed while delivering the driving force to the wheel(s) possible to grip the road surface, when the vehicle 1 travels on e.g., a muddy road surface, a rocky road surface on which the wheel may be stuck between rocks, a narrow road where the vehicle 1 may rub against the side obstacle, and a sandy road surface. That is, the wheel speed control system is configured to maintain speeds of the drive wheels to a constant speed, and to this end, a signal representing a selected speed of the drive wheel is transmitted from a speed selector dial 27 to the HV-ECU 16 via the four-wheel drive control unit 26.

In order to maintain the speed of the vehicle 1 to a predetermined low speed under the particular set of conditions, the HV-ECU 16 controls the driving force and the braking force based on the above-mentioned incident data. To this end, the HV-ECU transmits command signals to the after-mentioned electronic control units. According to the exemplary embodiment of the present disclosure, the brakes 28 of the wheels 7 and 8 are actuated hydraulically upon reception of a hydraulic command transmitted from a brake control unit (indicated as “BRAKE-ECU” in FIG. 2) 29. Specifically, the brake control unit 29 is configured to calculate a hydraulic command value to maintain the speed of the vehicle 1 to a target speed during execution of a constant wheel speed control upon reception of a start signal of the constant wheel speed control transmitted from the HV-ECU 16. The calculated hydraulic command is transmitted from the brake control unit 29 to the brakes 28.

The first motor 3 and the second motor 13 are controlled by a motor control unit (indicated as “MG-ECU” in FIG. 2) 30. In order to maintain the speed of the vehicle 1 to the target speed under the particular set of conditions, for example, the motor control unit 30 transmits a voltage command to the first motor 3. In addition, the motor control unit 30 transmits a discharging command to the second motor 13 to generate a driving torque by supplying the electric power to the second motor 13 from the electric storage device 15, or transmits a charging command to the second motor 13 to charge the electric storage device 15 by generating regenerative braking torque. To this end, the HV-ECU 16 transmits data relating to the target speed as a target vehicle speed to the motor control unit 30. In addition, signals representing speeds of the first motor 3 and the second motor 13 are transmitted to the motor control unit 30 from resolvers 31 arranged in the motors 3 and 13. Further, the motor control unit 30 also calculates a required driving force to propel the vehicle 1 at the target speed, and controls the first motor 3 and the second motor 13 in such a manner as to achieve the required driving force. The required driving force calculated by the motor control unit 30 is also transmitted to the brake control unit 29.

An output torque of the engine 2 is controlled by an electronic fuel injection control unit (indicated as “EFI-ECU” in FIG. 2) 32. Specifically, the electronic fuel injection control unit 32 is configured to calculate a required torque of the engine 2 to maintain the speed of the vehicle 1 to the target speed, and to transmit a command to generate the required torque to the engine 2. To this end, the HV-ECU 16 transmits a target driving force to the electronic fuel injection control unit 32.

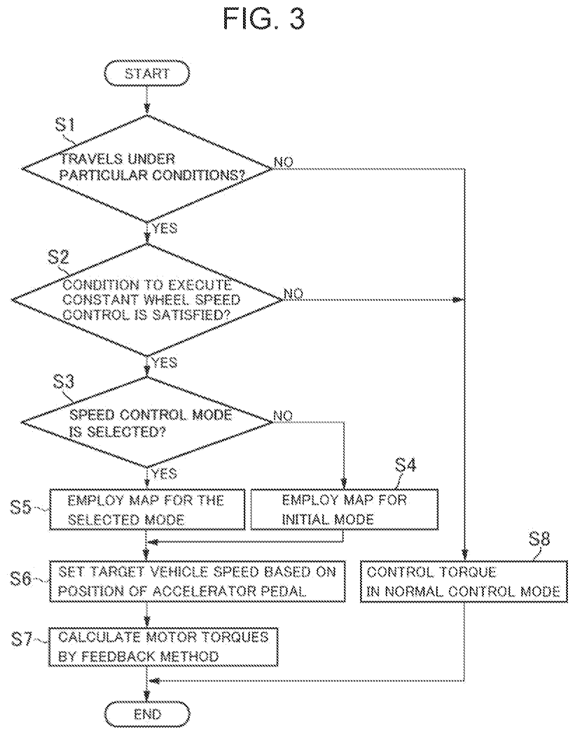

In order to allow the vehicle 1 to propel smoothly and stably under a particular set of conditions, the HV-ECU 16 comprises a running condition determiner 16A, a mode selector 16B, and a driving force controller 16C. To this end, the HV-ECU 16 executes the routine shown in FIG. 3. At step S1, the running condition determiner 16A determines whether the vehicle 1 travels under the particular set of conditions. According to the exemplary embodiment of the present disclosure, the particular set of conditions includes: a road having a bump or step on which the vehicle 1 travels over; a rocky road on which any of the wheels 7 and 8 may be stuck between rocks; an uneven road on which any of the wheels 7 and 8 may be stuck between dents or holes; and a narrow road where a clearance between the vehicle 1 and the side obstacle is narrow. In addition, the particular set of conditions further includes an upslope, a downslope, a snow-covered road, and a sandy road. For example, the answer of step S1 will be YES in a case that a target vehicle speed in the selected speed control mode is set to a speed suitable to travel on the rocky road surface, or in a case that a clearance between the vehicle 1 and the side obstacle is narrowed to a limit value at which a warning is emitted and hence the vehicle 1 is stopped (by actuating the brakes 28) by the safety control unit 24.

If the answer of step S1 is YES, the routine progresses to step S2 to determine whether a condition to execute the constant wheel speed control is satisfied. Specifically, during execution of the constant wheel speed control, a target vehicle speed is set in accordance with a position (or operating amount) of the accelerator pedal Pa, and a driving force and a braking force are automatically controlled to adjust an actual speed of the vehicle 1 to the target vehicle speed. Optionally, the brakes 28 may be activated to adjust the actual speed of the vehicle 1 to the target vehicle speed. During execution of the constant wheel speed control, the driver D does not have to operate the accelerator pedal Pa and the brake pedal Pb more than necessary, and hence it is preferable that the driver D is allowed to recognize the execution of the constant wheel speed control. Therefore, a condition to execute the constant wheel speed control is satisfied based on an operation of the control mode selector switch 18 or the speed selector dial 27. For example, if the target speed (or the road condition) is selected by the control mode selector switch 18 or the speed selector dial 27 so that the answer of step S1 is YES, the answer of step S2 will also be YES. Otherwise, such determination at step S1 may also be made based on an on/off signal of another switch arranged instead of the speed selector dial 27.

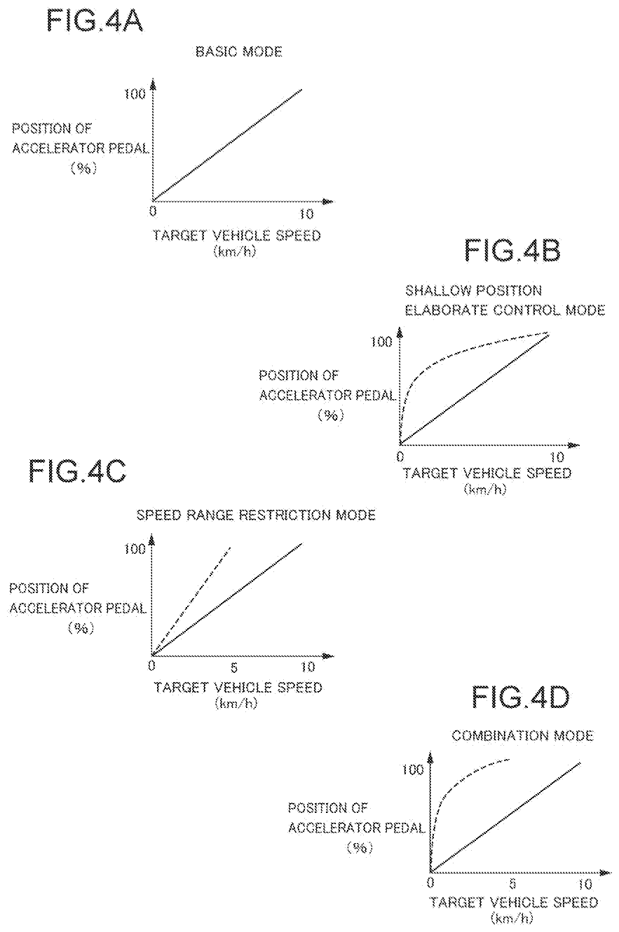

If the answer of step S2 is YES, the routine progresses to step S3 to determine whether the speed control mode is selected by the driver D. In the speed control mode, the target vehicle speed with respect to a position of the accelerator pedal Pa is set with reference to maps installed in the HV-ECU 16. Examples of the maps are shown in FIGS. 4A to 4D, and in FIGS. 4A to 4D, the maps are indicated as two-dimensional coordinates. In each of the maps shown in FIGS. 4A to 4D, the vertical axis represents a position of the accelerator pedal Pa, and the horizontal axis represents a target vehicle speed. In the speed control mode, specifically, a maximum speed of the vehicle 1 is limited, and a target speed of the vehicle 1 is determined with respect to an operating amount or a position of the accelerator pedal Pa.

FIG. 4A shows an example of the map employed in a basic mode. In the basic mode, the maximum vehicle speed achieved by fully depressing the accelerator pedal Pa (indicated as 100% in FIG. 4A) is limited to 10 km/h, and the target vehicle speed is increased substantially linearly or stepwise in proportion to an increase in depression of the accelerator pedal Pa from 0 to 10 km/h. In FIG. 4A, therefore, the target vehicle speed with respect to the position of the accelerator pedal Pa is indicated as a linear function.

FIG. 4B shows an example of the map employed in a shallow position elaborate control mode. In FIG. 4B, a relation between the position of the accelerator pedal Pa and the target vehicle speed in the shallow position elaborate control mode is indicated by the dashed curve, and the relation between the position of the accelerator pedal Pa and the target vehicle speed in the basic mode is indicated by the solid line. As indicated by the dashed curve, in the shallow position elaborate control mode, the maximum vehicle speed is also limited to the same speed as that in the basic mode. Specifically, in the shallow position range of the accelerator pedal Pa, an amount of change in the target vehicle speed with respect to an amount of change in the position of the accelerator pedal Pa is small. By contrast, in the position range of the accelerator pedal Pa deeper than a predetermined angle, an amount of change in the target vehicle speed with respect to an amount of change in the position of the accelerator pedal Pa is large. In FIG. 4B, therefore, the target vehicle speed with respect to the position of the accelerator pedal Pa is indicated as a logarithm function or a non-linear curve similar to the logarithm function. In the shallow position elaborate control mode, the target vehicle speed will not be changed significantly even if the accelerator pedal Pa is depressed or returned significantly within the shallow position range of the accelerator pedal Pa. Therefore, the target vehicle speed may be changed in an elaborate manner.

FIG. 4C shows an example of the map employed in a speed range restriction mode. In FIG. 4C, a relation between the position of the accelerator pedal Pa and the target vehicle speed in the speed range restriction mode is indicated by the dashed line, and the relation between the position of the accelerator pedal Pa and the target vehicle speed in the basic mode is indicated by the solid line. In the speed range restriction mode, the maximum vehicle speed achieved by fully depressing the accelerator pedal Pa (indicated as 100% in FIG. 4A) is limited lower than that in the basic mode (e.g., to a half speed of the maximum speed in the basic mode), and the target vehicle speed is increased linearly in proportion to an increase in depression of the accelerator pedal Pa from 0 to e.g., 5 km/h. As indicated by the dashed line in FIG. 4C, in the speed range restriction mode, the target vehicle speed is increased with respect to an increase in depression of the accelerator pedal Pa at a higher rate compared to the basic mode. In the speed range restriction mode, therefore, an amount of change in the target vehicle speed with respect to an amount of change in the position of the accelerator pedal Pa is smaller than that in the basic mode. For this reason, the target vehicle speed may be set more elaborate compared to the basic mode.

FIG. 4D shows an example of the map employed in a combination mode of the shallow position elaborate control mode and the speed range restriction mode. In FIG. 4D, a relation between the position of the accelerator pedal Pa and the target vehicle speed in the combination mode is indicated by the dashed curve, and the relation between the position of the accelerator pedal Pa and the target vehicle speed in the basic mode is indicated by the solid line. In the combination mode, therefore, the vehicle speed will not be increased more than expected even if the accelerator pedal Pa is accidentally depressed more than necessary. In addition, an amount of change in the target vehicle speed with respect to an amount of change in the position of the accelerator pedal Pa is further reduced, and hence the target vehicle speed may be set more elaborate compared to the foregoing modes.

For example, the maps shown in FIGS. 4A to 4D may be indicated in a display (i.e., a touch panel) of the navigation system 21 so that the driver D is allowed to select a desired speed control mode by touching the desired speed control mode indicated in the display. In this case, a predetermined speed control mode may be indicated initially in the display (hereinafter referred to as initial mode), and the initial mode may be selected automatically. Other speed control modes may be selected by scrolling the speed control modes to the desired mode in the display, and by touching e.g., an OK button. Thus, the touch panel of the navigation system 21 may be adopted as a selector switch.

Turning back to FIG. 3, the answer of step S3 will be NO if the speed control mode is not changed from the initial mode, and the answer of step S3 will be YES if the speed control mode other than the initial mode is selected by the driver D. Specifically, if the speed control mode is not changed from the initial mode so that the answer of step S3 is NO, the routine progresses to step S4 to control the vehicle speed or driving force during propulsion under the particular set of conditions with reference to the map for the initial mode. By contrast, if the speed control mode other than the initial mode is selected by the driver D so that the answer of step S3 is YES, the routine progresses to step S5 to control the vehicle speed or driving force during propulsion under the particular conditions with reference to the map for the speed control mode selected by the driver D. Specifically, the above-explained determination at step S3 and controls of the vehicle speed at step S4 or S5 are carried out by the mode selector 16B.

Then, at step S6, the target vehicle speed with respect to the position of the accelerator pedal Pa is set based on the selected speed change mode, and command signals to control the driving force and the braking force to achieve the target vehicle speed are transmitted to the motor control unit 30, the electronic fuel injection control unit 32, and the brake control unit 29. Thereafter, at step S7, the driving force and the braking force are controlled to achieve the target vehicle speed based on the command signals. In the vehicle 1, the prime mover 4 includes the first motor 3, and the driving force to rotate the front wheels 8 may be controlled by the second motor 13. Since the first motor 3 and the second motor 13 may respond to the control command promptly, at step S7, torque commands of the first motor 3 and the second motor 13 are calculated by a feedback method based on a difference between the actual speed of the vehicle 1 and the target vehicle speed, and the calculated torque commands are transmitted to the first motor 3 and the second motor 13. Specifically, the above-explained setting of the target vehicle speed at step S6 and calculation of the torque commands at step S7 are carried out by the driving force controller 16C.

If the answer of step S1 or S2 is NO, the routine progresses to step S8 to control the driving force in a normal control mode. In the normal control mode, the driving force and the vehicle speed are controlled in response to an operation of the driver D and in an energy efficient manner.

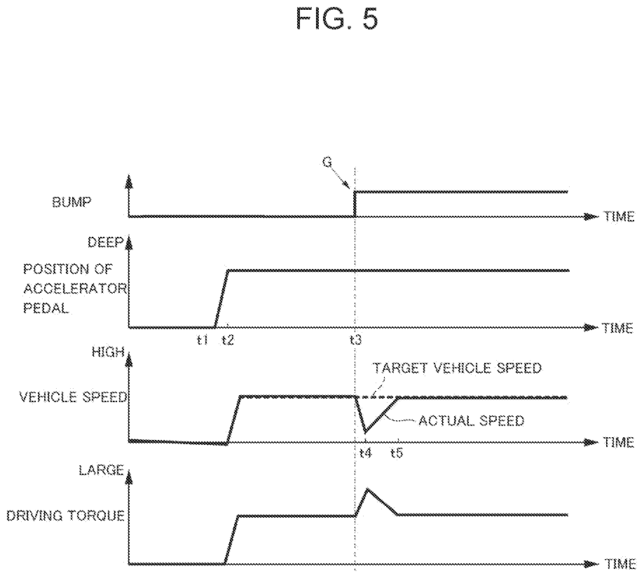

Turning to FIG. 5, there are shown temporal changes in the vehicle speed and the driving torque during execution of the routine shown in FIG. 3. In the situation shown in FIG. 5, the running condition determiner 16A has already determined that the vehicle 1 will travel over a bump, and the speed control mode has been selected by the driver D. At point t1, the driver depresses the accelerator pedal Pa to travel over the bump. Consequently, the driving torque is increased to increase the speed of the vehicle 1 to the target vehicle speed in response to depression of the accelerator pedal Pa. In this situation, the speed of the vehicle 1 is changed based on the selected speed change mode. For example, given that the shallow position elaborate control mode shown in FIG. 4B has been selected, the speed of the vehicle 1 would be changed mildly with respect to the depression of the accelerator pedal Pa, and the maximum speed of the vehicle 1 is limited to a predetermined speed.

When a position of the accelerator pedal Pa is fixed at point t2, the vehicle 1 is maintained to a constant speed in accordance with the position of the accelerator pedal Pa. Thus, when the accelerator pedal Pa is being depressed, the actual speed of the vehicle 1 is increased with the depression of the accelerator pedal Pa without delay, based on the target vehicle speed being increased at a rate governed by the selected speed control mode. As described, in the shallow position elaborate control mode, an amount of change in the target vehicle speed (i.e., the actual vehicle speed) with respect to an amount of change in the position of the accelerator pedal Pa is small and hence the target vehicle speed may be controlled sensitively. In this case, since the driver D has selected the shallow position elaborate control mode on his/her own will, the driver D will not be frustrated by such reduction in the change in the vehicle speed with respect to the amount of change in the position of the accelerator pedal Pa. In this situation, although the vehicle 1 has already been propelled in the shallow position elaborate control mode, a road load is constant until the vehicle 1 reaches a bump G. In this situation, therefore, the actual speed of the vehicle 1 indicated by the solid line is maintained to the target vehicle speed indicated by the dashed line, and the driving force is maintained as before.

When the vehicle 1 reaches the bump G at point t3, the actual speed of the vehicle 1 is reduced from the target vehicle speed with an increase in the road load. In this situation, the driving torque is increased to raise the actual speed of the vehicle 1 to the target vehicle speed. Eventually, the driving torque is increased to a required magnitude to drive over the bump G at point t4 so that the vehicle 1 starts climbing the bump G. In this situation, the road load is reduced while the vehicle 1 is climbing the bump. Consequently, the torque increased to the required magnitude to drive over the bump G becomes excessive so that the actual speed of the vehicle 1 is increased by such excess torque. As a result, the difference between the actual speed of the vehicle 1 and the target vehicle speed is reduced, and the driving torque is reduced gradually with an increase in the actual speed of the vehicle 1.

Thereafter, when the actual speed of the vehicle 1 is increased to the target vehicle speed at point t5, the driving torque is maintained to maintain the actual speed of the vehicle 1 to the target vehicle speed. Thus, the actual speed of the vehicle 1 does not exceed the target vehicle speed when travelling over the bump G. That is, the actual speed of the vehicle 1 will not be increased abruptly and undesirably even after passing the bump G.

After passing the bump G, the vehicle 1 is temporarily stopped to terminate the speed control mode. For example, the control of the speed of the vehicle 1 and the driving force in the selected speed control mode may be terminated by rotating the speed selector dial 27 to an initial position. Consequently, the vehicle 1 is propelled in the normal control mode.

Although the above exemplary embodiment of the present disclosure has been described, it will be understood by those skilled in the art that the present disclosure should not be limited to the described exemplary embodiments, and various changes and modifications can be made within the scope of the present disclosure. For example, each step of the routine shown in FIG. 3 may be executed not only manually based on operations of the above-mentioned switches by the driver D, but also automatically based on driving conditions of the vehicle 1 as well as positional information and road information obtained by the navigation system 21. In addition, the routine shown in FIG. 3 may also be executed during propulsion on e.g., a downslope on which a road load is reduced. In this case, the target vehicle speed will be set based on an operation of the brake pedal Pb to control the braking force. To this end, the target vehicle speed will be set with reference to other maps in which lines representing the target vehicle speeds are inclined opposite to those in FIGS. 4A to 4D.

Here will be explained an example of controlling the target vehicle speed during propulsion on a frozen road surface on which a friction coefficient is lower than that on a dry road surface, a rocky road surface on which the wheel may be stuck between rocks or in a dent, a muddy road surface, a snow-covered slippery road surface on which a resistance is large, or a narrow road. In those cases, the shallow position elaborate control mode or the combination mode is selected. In those cases, when the accelerator pedal Pa is depressed by the driver D to propel the vehicle 1, the target vehicle speed is set with reference to the map shown in FIG. 4B or 4D. As described, the target vehicle speed will not be increased significantly in those modes even if the accelerator pedal Pa is depressed deeply in the initial phase. Likewise, the target vehicle speed will not be reduced significantly in those modes even if the accelerator pedal Pa is returned significantly in the initial phase. Therefore, the target vehicle speed may also be controlled in an elaborate manner even in a situation where the driver D is not allowed to operate the accelerator pedal Pa sensitively.

For example, during propulsion on the road surface on which the friction coefficient is low, the driving force may be maintained to a magnitude at which the drive wheels will not slip significantly. In this case, therefore, the vehicle 1 is allowed to travel through the road surface on which the friction coefficient is low at a predetermined low speed without losing control. Likewise, the vehicle 1 is also allowed to travel through the muddy road surface or snow-covered road surface without slipping. In other words, the vehicle 1 is also allowed to travel through the muddy road surface or snow-covered road surface without being stuck. Further, since the speed of the vehicle 1 may be controlled sensitively in a low speed range, the vehicle 1 is allowed to travel through the narrow road without rubbing against the side obstacle. Thus, according to the exemplary embodiment of the present disclosure, the vehicle 1 is allowed to travel under the particular conditions smoothly and easily.

What is claimed is:

1. A vehicle control system that controls a driving force delivered from a prime mover to wheels in accordance with an accelerating operation or a decelerating operation, comprising:
a controller that controls a speed of a vehicle,
wherein the controller comprises:
a running condition determiner that determines whether the vehicle travels under a particular set of conditions in which a maximum speed of the vehicle has to be limited;
a plurality of vehicle speed control modes each of which determines a relation between an amount of the accelerating operation or decelerating operation and a target vehicle speed under the particular set of conditions;
a control mode selector that selects one of the vehicle speed control modes; and
a driving force controller that controls the driving force such that an actual vehicle speed is adjusted to the target vehicle speed based on the selected vehicle speed control mode.

2. The vehicle control system as claimed in claim 1, wherein the vehicle includes an electric vehicle in which the prime mover includes a motor that generates the driving force.

3. The vehicle control system as claimed in claim 1, wherein the particular set of conditions include:
a road surface having a bump on which the vehicle travels over;
an uneven road surface on which any of the wheels may be stuck between bumps or in a dent; and
a slippery road surface on which a friction coefficient is lower than that on a dry road surface.

4. The vehicle control system as claimed in claim 1,
wherein the vehicle comprises a safety system that gives a warning when a clearance between the vehicle and an obstacle is a predetermined value or narrower, and
the particular set of conditions further includes a narrow road on which the safety system gives the warning.

5. The vehicle control system as claimed in claim 1, wherein any of the vehicle speed control mode is configured to determine the relation between the amount of the accelerating operation or decelerating operation and the target vehicle speed linearly or non-linearly, or limit a maximum target vehicle speed to a value different from a maximum speed in the other vehicle speed control modes.

6. The vehicle control system as claimed in claim 1, wherein the control mode selector is configured to select the one of the vehicle speed control modes based on a signal transmitted from a switch that is operated manually by a driver of the vehicle.
